(19) United States
(12) Patent Application Publication
(10) Pub. No.: US 2010/0194016 A1
(43) Pub. Date: Aug. 5, 2010

(54) Versatile cutting board for kitchen use

(76) Inventor: Sam Tung Tsui, Hong Kong (CN)

Correspondence Address: THE NATH LAW GROUP, 112 South West Street, Alexandria, VA, 22314, US

(21) Appl. No.: 12/320,716

(22) Filed: Feb. 3, 2009

(51) Int. Cl. B23Q 3/00; B29C 45/14

(52) U.S. Cl. 269/302.1; 264/263

(57) ABSTRACT

In various embodiments, a planar cutting board having two different cutting surfaces includes a first portion being made of at least one of wood and bamboo, and a second portion of a man-made material, wherein the first portion having a silicone lattice sheath installed in a planar surface, is fitted at least partially within the second portion such that a first surface of at least one of wood and bamboo is available for use on a first side of the cutting board, and the man-made material is available for use on a second side of the cutting board and having a silicone layer situated in between the two portions.

### BACKGROUND

I. Field

This disclosure relates to cutting boards having increased utility.

II. Background

Cutting boards are well known devices used to cut food while protecting a countertop surface from being marred by a knife or other sharp object. In practice, a wide range of materials, such as wood, plastic and marble have been used as cutting board materials with each material having its own advantages. For example, wood tends to be rigid but softer than a knife blade, thus preventing damage to the knife blade.

However, as no cutting board material tends to be perfect for all uses, there is further need for a cutting board which is economical to manufacture, yet has increased versatility.

### SUMMARY

Various aspects and embodiments of the invention are described in further detail below.

In a first series of embodiments, a planar cutting board having two different cutting surfaces includes a first portion being made of at least one of wood and bamboo, and a second portion of a man-made material, wherein the first portion is fitted at least partially within the second portion such that a first surface of at least one of wood and bamboo is available for use on a first side of the cutting board, and the man-made material is available for use on a second side of the cutting board.

In another series of embodiments, a method for manufacturing a planar cutting board having two different cutting surfaces includes forming a mother board of a man-made material via injection molding, while the mother board is hot, inserting a first portion being made of at least one of wood and bamboo partially into the mother board, and cooling the mother board so that the mother board shrinks to fit about the first portion to form a cutting board wherein a first surface of at least one of wood and bamboo is available for use on a first side of the cutting board, and the man-made material is available for use on a second side of the cutting board.

In yet another series of embodiments, a planar cutting board having two different cutting surfaces includes a first portion being made of at least one of wood and bamboo, wherein the first portion includes at least one of a flange, protrusion or spike on its perimeter, a second portion of a man-made material, wherein the first portion is fitted at least partially within the second portion such that a first surface of at least one of wood and bamboo is available for use on a first side of the cutting board, and the man-made material is available for use on a second side of the cutting board, wherein the second portion includes a groove to complement the respective flange, protrusion or spike on the perimeter of the first portion, and wherein the second side has a coarse or rough texture and the second portion is made of at least one of polypropylene and nylon, and a silicone sheath situated between the first portion and the second portion.

### BRIEF DESCRIPTION OF THE DRAWINGS

The features and nature of the present disclosure will become more apparent from the detailed description set forth below when taken in conjunction with the accompanying drawings in which reference characters identify corresponding items.

FIG. 1A is a top view of the exemplary cutting board,

FIG. 1B is a longitudinal cross section of the exemplary cutting board,

FIG. 1C is a latitudinal cross section of the exemplary cutting board,

FIG. 2A is a top view of a first portion of the cutting board,

FIG. 2B is a longitudinal side view of the first portion of the cutting board,

FIG. 2C is a longitudinal cross section of the first portion of the cutting board,

FIG. 2D is a latitudinal side view of the first portion of the cutting board,

FIG. 3A is a top view of the first portion of the cutting board of FIGS. 1A-1C with the silicone lattice sheath installed,

FIG. 3B is a longitudinal cross section of the first portion of the cutting board with the silicone lattice sheath installed,

FIG. 3C is a latitudinal side view of the first portion of the cutting board of with the silicone lattice sheath installed,

FIGS. 4 and 5 depict aspects of the assembly of the cutting board of FIG. 1,

FIG. 6A is a top view of a second exemplary cutting board,

FIG. 6B is a longitudinal cross section of the exemplary cutting board,

FIG. 6C is a latitudinal cross section of the exemplary cutting board,

FIG. 7A is a top view of a first portion of the cutting board of FIG. 6,

FIG. 7B is a longitudinal side view of the first portion of the cutting board of FIG. 6,

FIG. 7C is a latitudinal cross section of the first portion of the cutting board of FIG. 6,

FIG. 7D is a latitudinal side view of the first portion of the cutting board of FIG. 6,

FIG. 8A is a top view of a first portion of the cutting board of FIG. 6A-6C with a silicone lattice sheath installed in a planar surface leaving the other side of the planar surface open for cutting,

FIG. 8B is a longitudinal side view of the first portion of the cutting board,

FIG. 8C is a longitudinal cross section of the first portion of the cutting board with a silicone lattice sheath installed,

FIG. 8D is a latitudinal side view of the first portion of the cutting board with the silicone lattice sheath installed,

FIG. 8E is a latitudinal cross section of the first portion of the cutting board with the silicone lattice sheath installed,

FIGS. 9 and 10 depict an aspect of the assembly of the cutting board of FIGS. 6A-6C, FIGS. 11 and 12 are perspective drawings of planar sides of the exemplary cutting board of FIGS. 1A-1C, and

FIGS. 13-15 are perspective drawings of a modified version of the cutting board of FIG. 1 that incorporates a strainer.

### DETAILED DESCRIPTION

The disclosed methods and devices below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

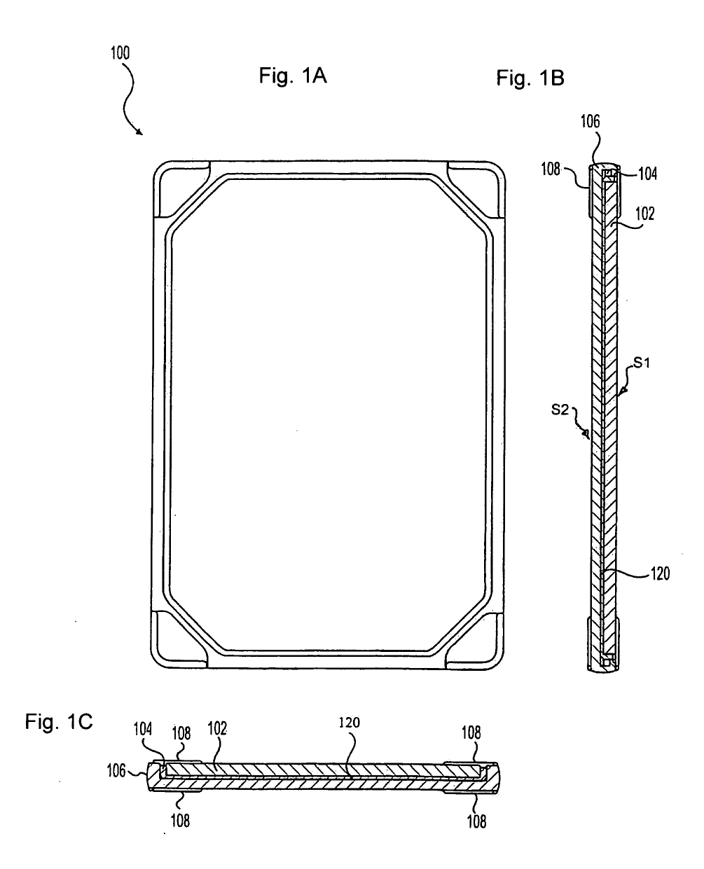

FIGS. 1A-1C depict a first exemplary cutting board 100. The exemplary cutting board 100 includes a first portion 102 having a number of flanges 104, a second portion 106 having grooves (not shown in FIG. 1) complementary to the flanges 104, and a number of skid-prevention structures 108. As shown in FIGS. 1B, 1C, 9 and 10, a silicone lattice sheath 120 is situated in between the first portion 102 and the second portion 106 of the cutting board 100.

The exemplary cutting board 100 may be used as a “2-in-1” cutting device. On one side, a polypropylene material (or other suitable material, such as plastic, nylon, silicone and other durable) may be used noting that the surface of such side, a part of the second portion 106 (S2 in FIG. 1B) may have a coarse or rough texture for cutting fruits, vegetables or breads. On the other side, wood, bamboo or other similar material for cutting meats on the surface of the first portion 102 (S1 in FIG. 1B) may be used. For the example of FIG. 1, the first portion 102 is made of wood while the second portion 106 is made of polypropylene.

As shown in FIG. 1, the exemplary cutting board 100 is generally rectangular in shape, although as will be seen below other shapes, such as oval and circular, are feasible. FIGS. 11 and 12 are respective perspective drawings of each side of the cutting board of FIG. 1 provided for a better visualization of the exemplary embodiment.

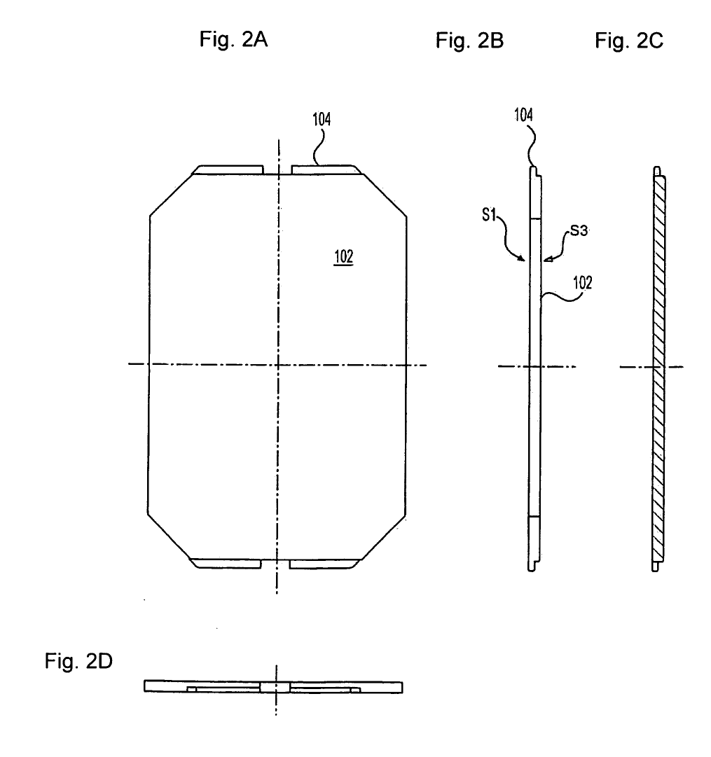

FIG. 2 depicts the first portion 102 of the cutting board 100 of FIG. 1. As shown in FIG. 2A, the first portion 102 is generally rectangular, and a number of flanges 104 project from the perimeter of the first portion 102. Generally, such flanges 104 may be about 5 mm in length (FIGS. 2B and 2D) noting that other forms of protrusions, such as spikes, may alternatively be used. Note that the first portion 102 may optionally include a thin silicone lattice sheath 120 covering its planar surface S3 so as to allow the first portion 102 to better sit within the second portion 106.

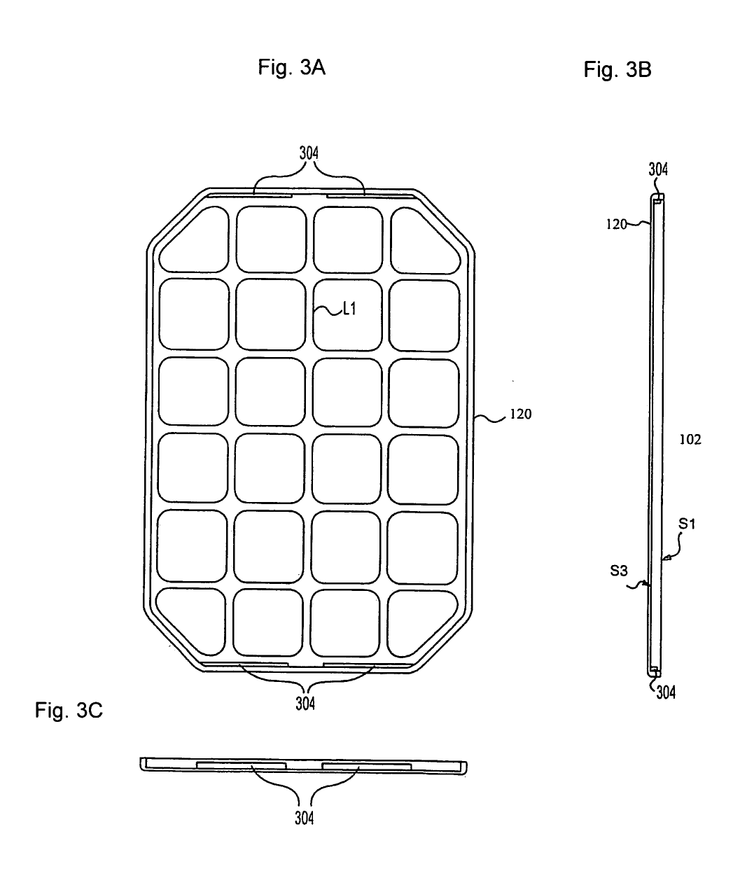

FIG. 3 depicts the a part of the first portion 102 of the cutting board 100 of FIG. 1 with a silicone lattice sheath 120 being installed at its planar surface S3 leaving the other planar surface S1 open for cutting purpose. This assembly will be incorporated into the second portion 106 (“the mother board”) (as shown in FIG. 1A) to form a “2-in-1” cutting board. As shown in FIG. 3A, the first portion 102 and the silicone lattice sheath 120 are also generally rectangular, and a number of grooves with holes 304 are incorporated in the silicone lattice sheath 120 to allow the flanges 104 of the first portion 102 of the cutting board 100 to complement through them and leaving the flanges opened up. Note that an inner lattice L1 improves the structural support of the “2-in-1” cutting board; while the outer planar surface of the first portion S1 and the outer planar surface of the second portion S2 (FIG. 1B) can be used for cutting purposes. The second portion 106 encased and embedded the flanges 104 (or protrusions or spikes) of the first portion 102 and having the silicone lattice sheath 120 situated in between the first portion 102 and the second portion 106 (FIG. 1B).

In practice, the second portion 106 may be manufactured via injection molding, and when hot will have expanded perimeters. Accordingly, the edges second portion 106 will be “opened up” relative to the perimeter of the first portion 102 with a silicone lattice sheath 120 installed before cooling down.

While the second portion 106 is hot, the first portion 102 with a silicone lattice sheath 120 may be partially installed into and seated firmly within the second portion 106.

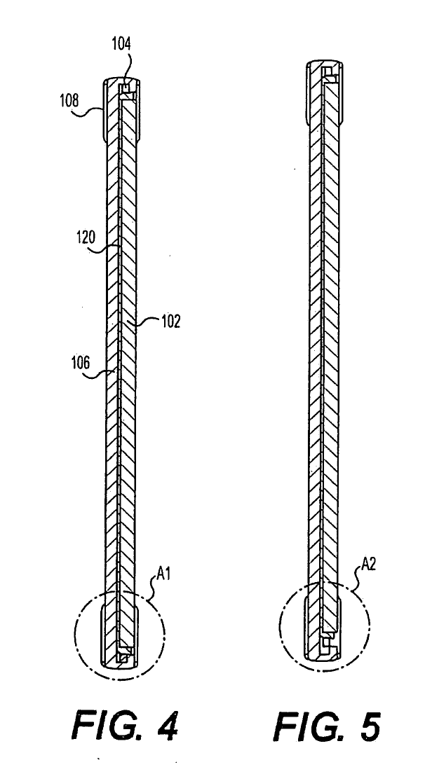

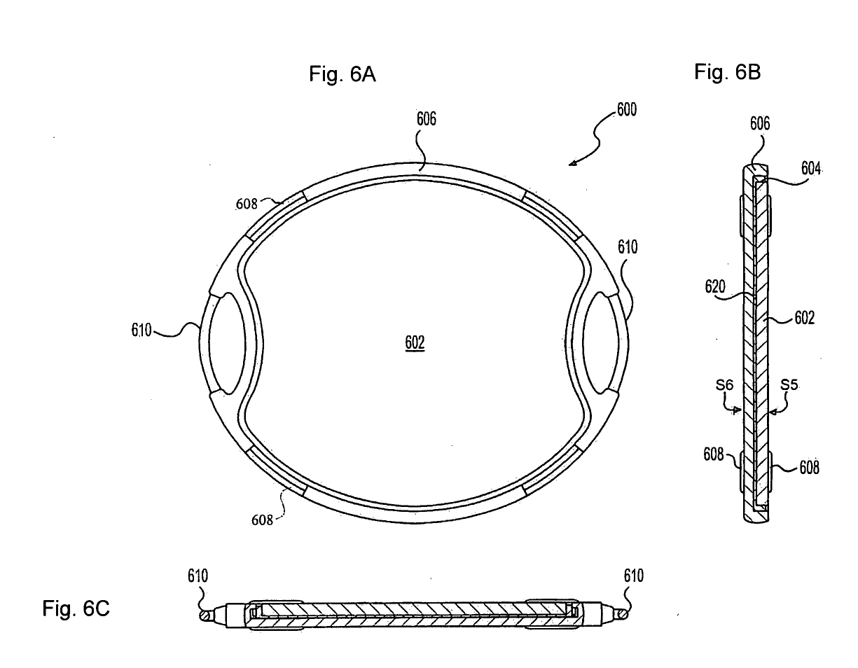

When the second portion 106 cools under a suitable condition, it will harden, and the size of its perimeters will get smaller so that its edges will close automatically to encase and embed the flanges 104 (or protrusions or spikes) of the first portion 102. Thus, the two portions 102 and 106 with 120 in between may be interlocked firmly, seamlessly and naturally with one another as a “2-in-1” cutting board having two different surface materials on each side. FIGS. 4 and 5 depict the relative shrinking of the second portion 106 with special attention given to areas A1/A2.

In use, the second portion 106 (or “mother board”) will hold the first portion firmly and seamlessly using the aforementioned layer of silicone there between to absorb and to prevent fictional force being created within the “2-in-1” cutting board 100, as the silicone layer will act as a cushion between the two different materials while in use.

Note that the thin layer of silicone sheath may wrap up and cover one surface of the first portion 102 but leaving the flanges 104 open. Accordingly, during the installation process (which may include optionally applying suitable compression force to the boards), the first portion 102 can sit firmly inside the second portion 106 and interlocked with it firmly, seamlessly and naturally.

In this way, the silicone layer in between them will also prevent collision, movement or dislodgement of the two boards in the “2-in-1” cutting board in all directions. This silicone layer also acts as a water-proof cushion in between the two different material boards. This will ensure and improve flexibility and durability of the cutting board.

Continuing, the four corners of the cutting board 100 may be covered by Thermoplastic Elastomer traction gloves to form the skid-prevention structures 108. Other suitable materials, such as plastic, silicone and other durable, light weight materials may be considered for use, to prevent skidding and slip when in use.

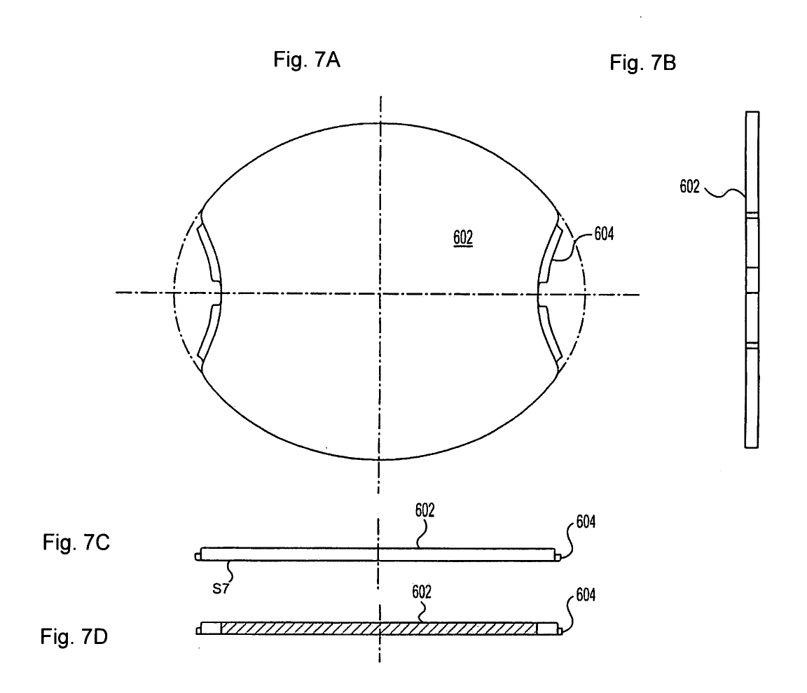

FIGS. 6A-6C depict a second exemplary cutting board 600. The second exemplary cutting board 600 includes a first structural portion 602 having a number of flanges 604, a second portion 606 having grooves (not shown in FIG. 6) complementary to the flanges 604, and a number of skid-prevention structures 608 (FIG. 6A). A silicone lattice sheath 620 is situated in between the first portion 602 and the second portion 606 of the cutting board of FIG. 6 (B and C of FIG. 6). Handles 610 are also incorporated into the present example.

As with the first exemplary cutting board 100 of FIGS. 1-5, the second exemplary cutting board 600 may be used as a “2-in-1” cutting device with similar respective materials being used for the respective first and second portions 102/602 and 106/606.

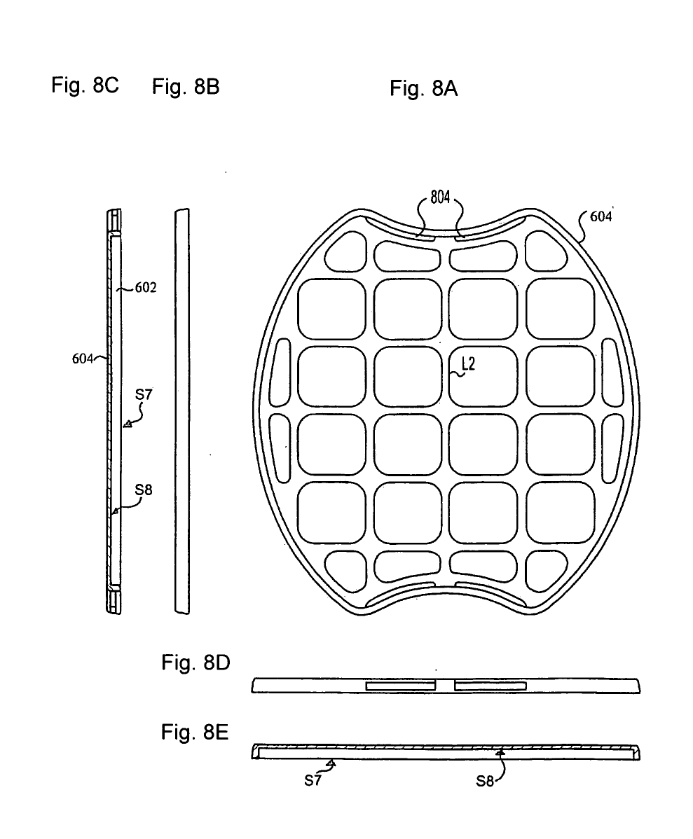

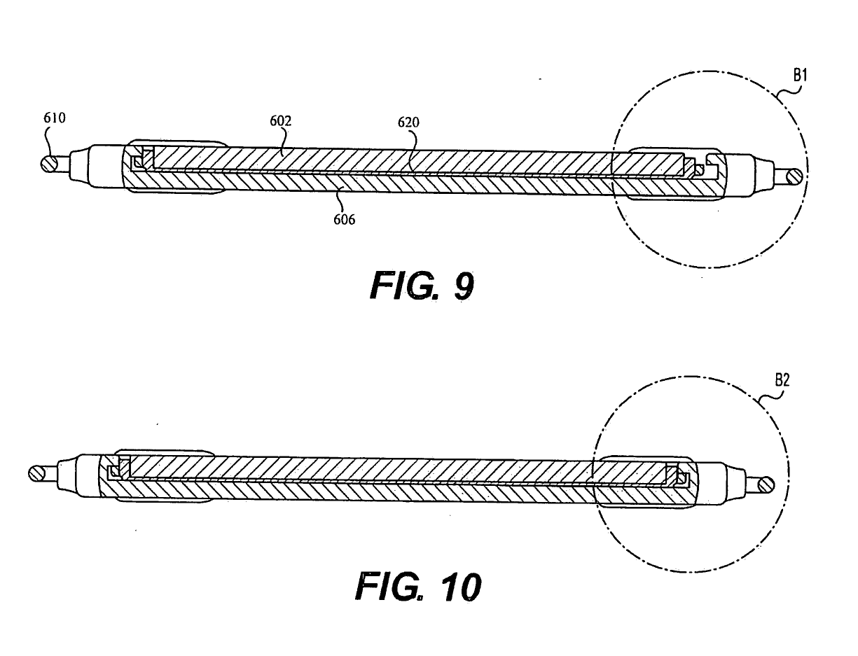

FIGS. 7A-7D depict the first portion 602 of the cutting board 600 of FIG. 6. As shown, the first portion 602 is generally oval, and a number of flanges 604 project from the perimeter of the first portion 602. Again, as with the example of FIGS. 1-5, the first portion 102 may optionally include a thin silicone lattice sheath 620 covering its planar surface S8 (FIG. 8C) so as to allow the first portion 602 to better sit within the second portion 606.

FIGS. 8A-8E depict a part of the first portion 602 of the cutting board 600 of FIG. 6 with a silicone lattice sheath 604 installed at its planar surface S8 and leaving the other side of the planar surface S7 open for cutting purpose. This assembly will then be incorporated into the second portion 606 (as shown in FIG. 6). As shown, the first portion 602 and the silicone lattice sheath 604 are also generally oval, and a number of grooves with holes 804 are incorporated in the silicone lattice sheath 604 to allow the flanges 604 of the first portion 602 of the cutting board 600 to complement through them and leaving the flanges 604 opened up. Note that the inner lattice L2 improves the structural support of the “2-in-1” cutting board; while the outer planar surface of the first portion S5 and the outer planar surface of the second portion S6 (FIG. 6B) can be used for cutting purposes. The second portion 606 encased and embedded the flanges 604 (or protrusions or spikes) of the first portion 602 and having the silicone lattice sheath 620 situated in between the first portion 602 and the second portion 606 (FIG. 6B).

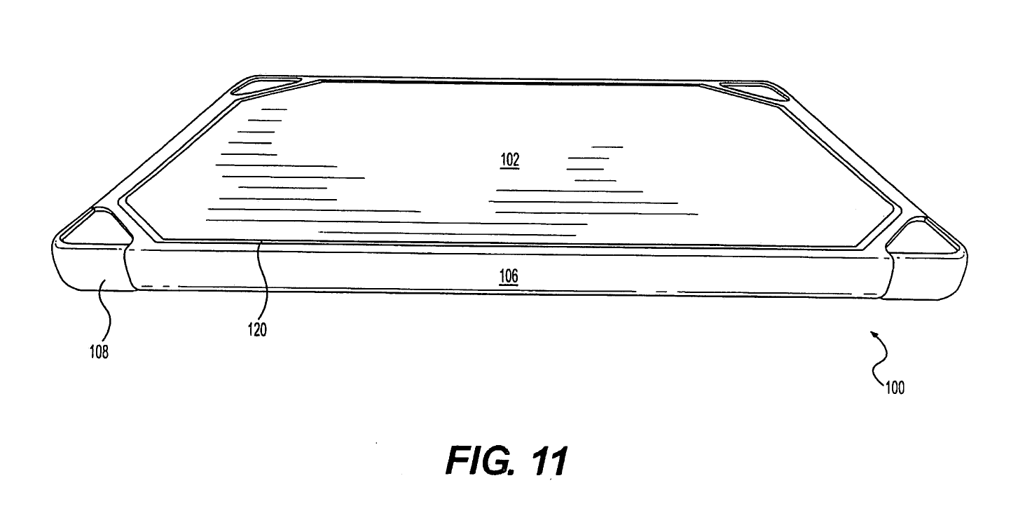

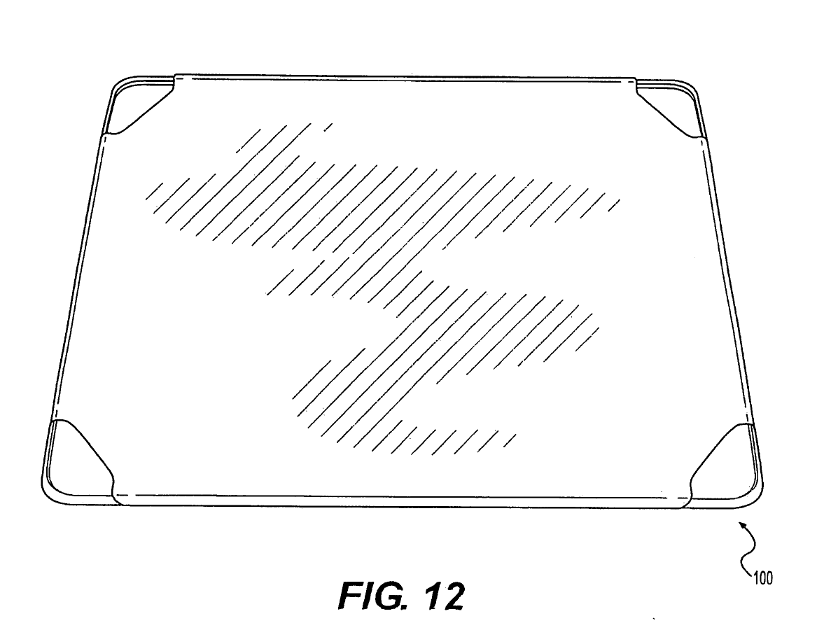

As with the example of FIGS. 1-5, the second portion 606 may be similarly manufactured and fitted to the first portion 602 (having a silicone lattice sheath 604 installed) with FIGS. 9 and 10 depicting the relative shrinking of the second portion 606 with special attention given to areas B1/B2.

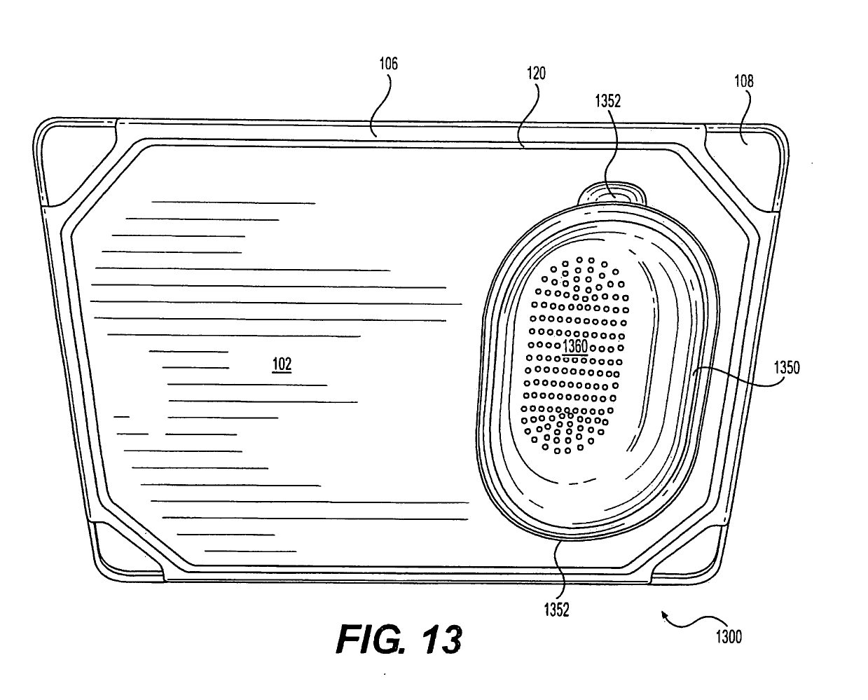

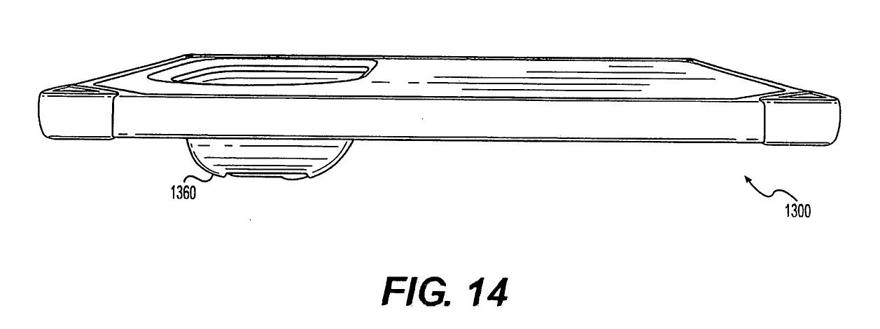

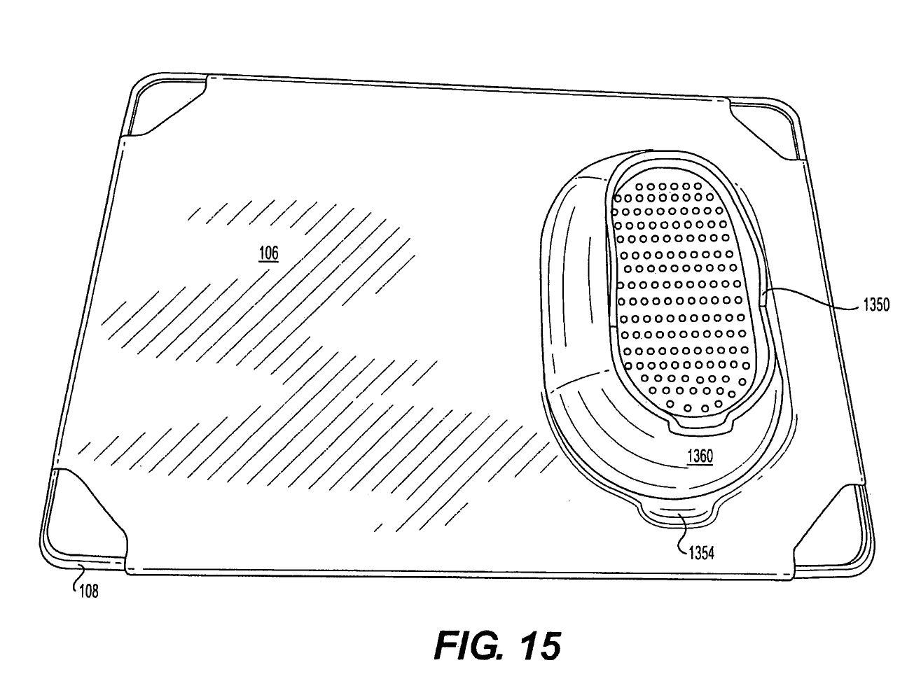

FIGS. 13-15 are perspective drawings of a modified version of the cutting board of FIG. 1 that incorporates a strainer 1360 noting that a similar strainer may also be incorporated into the example of FIG. 6. As shown in FIGS. 13-15, the modified cutting board 1300 may contain all the elements 102-120 of the cutting board 100 of FIG. 1 noting that a suitably shaped hole 1350 and indented contours 1352 and 1354 may be incorporated into the first and second portions 102 and 106 in order to accommodate strainer 1360.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A planar cutting board having two different cutting surfaces, comprising:
a first portion being made of at least one of wood and bamboo; and
a second portion of a man-made material, wherein the first portion is fitted at least partially within the second portion such that a first surface of at least one of wood and bamboo is available for use on a first side of the cutting board, and the man-made material is available for use on a second side of the cutting board.

2. The cutting board of claim 1, wherein the second side has a coarse or rough texture.

3. The cutting board of claim 1, wherein the second portion is made of at least one of polypropylene and nylon.

4. The cutting board of claim 1, further comprising a silicone sheath situated between the first portion and the second portion.

5. The cutting board of claim 4, wherein the sheath is made from silicone.

6. The cutting board of claim 4, wherein the sheath is made from a thermoplastic elastomer material.

7. The cutting board of claim 1, wherein the first portion includes at least one of a flange, protrusion or spike on its perimeter.

8. The cutting board of claim 1, wherein the second portion includes a groove to complement the respective flange, protrusion or spike on the perimeter of the first portion.

9. The cutting board of claim 1, wherein the first and second portions each include a hole operable to incorporate a strainer.

10. The cutting board of claim 9, further comprising a removable strainer having dimensions suitable for the holes of the first and second portions

11. A method for manufacturing a planar cutting board having two different cutting surfaces, the method comprising:
forming a mother board of a man-made material via injection molding;
while the mother board is hot, inserting a first portion being made of at least one of wood and bamboo at least partially into the mother board; and
cooling the mother board so that the mother board shrinks to fit about the first portion to form a cutting board wherein a first surface of at least one of wood and bamboo is available for use on a first side of the cutting board, and the man-made material is available for use on a second side of the cutting board.

12. The method of claim 11, wherein the second side has a coarse or rough texture.

13. The method of claim 11, wherein the second portion is made of at least one of polypropylene and nylon.

14. The method of claim 11, further comprising installing a silicone sheath situated between the first portion and the second portion.

15. The method of claim 14, wherein the sheath is made from at least one of silicone and a thermoplastic elastomer material.

16. The method of claim 11, wherein the first portion includes at least one of a flange, protrusion or spike on its perimeter.

17. The method of claim 16, wherein the second portion includes a grove to complement the respective flange, protrusion or spike on the perimeter of the first portion.

18. The method of claim 11, wherein the first and second portions each include a hole operable to incorporate a strainer.

19. A planar cutting board having two different cutting surfaces, comprising:
a first portion being made of at least one of wood and bamboo, wherein the first portion includes at least one of a flange, protrusion or spike on its perimeter;
a second portion of a man-made material, wherein the first portion is fitted at least partially within the second portion such that a first surface of at least one of wood and bamboo is available for use on a first side of the cutting board, and the man-made material is available for use on a second side of the cutting board, wherein the second portion includes a groove to complement the respective flange, protrusion or spike on the perimeter of the first portion, and wherein the second side has a coarse or rough texture and the second portion is made of at least one of polypropylene and nylon; and
a silicone sheath situated between the first portion and the second portion.

20. The cutting board of claim 19, further comprising a removable strainer having dimensions suitable for holes incorporated into the first and second portions.
